(19) United States
(12) Patent Application Publication
(10) Pub. No.: US 2023/0397057 A1
(43) Pub. Date: Dec. 7, 2023

(54) TERMINAL

(71) Applicant: NTT DOCOMO, INC., Tokyo (JP)

(72) Inventors: Hidekazu Shimodaira, Tokyo (JP); Tomoki Yokokawa, Tokyo (JP)

(73) Assignee: NTT DOCOMO, INC., Tokyo (JP)

(21) Appl. No.: 18/250,024

(22) PCT Filed: Oct. 23, 2020
(86) PCT No.: PCT/JP2020/039993

§ 371 Date: Apr. 21, 2023

(51) Int. Cl. H04W 36/00

(52) U.S. Cl. CPC H04W 36/0061

(57) ABSTRACT

A terminal includes: a reception unit that receives a first message requesting a configuration of a specific secondary cell configured with a physical uplink control channel; and a control unit that configures the specific secondary cell in response to the reception of the first message; wherein the control unit performs an activation of the specific secondary cell so as not to exceed a first request delay time in a first procedure for performing the activation of the specific secondary cell in response to receiving a second message requesting the activation of the specific secondary cell, and performs the activation of the specific secondary cell so as not to exceed a second request delay time in a second procedure for performing the activation of the specific secondary cell without depending on the second message.

### TECHNICAL FIELD

This disclosure relates to a terminal that performs radio communication, in particular, a terminal that performs activation of a secondary cell.

### BACKGROUND ART

The 3rd Generation Partnership Project (3GPP) has specified Long Term Evolution (LTE) and LTE-Advanced (hereinafter referred to as LTE, including LTE-Advanced) to further accelerate LTE. Furthermore. 3GPP has specified the 5th generation mobile communication system (Also known as 5G, New Radio (NR) or Next Generation (NG)) and is also in the process of specifying the next generation called Beyond 5G, 5G Evolution or 6G.

In LTE and NR, the RRC (Radio Resource Control) message causes the secondary cell (SCell; Secondary Cell) to be configured and the MAC CE (Medium Access Control Element) message causes the SCell to be activated.

In LTE, for SCell (hereinafter PUCCH SCell) configured with a physical uplink control channel (PUCCH), a delay time required to activate the PUCCH SCell is defined (Non-Patent Literature 1). On the other hand, NR specifies a method of performing SCell activation without relying on a MAC CE message (Direct SCell Activation) (Non-Patent Literature 2).

### CITATION LIST

### Non-Patent Literature

Non-Patent Literature 1: 3GPP TS36.133 V 16.7.0 3rd Generation Partnership Project; Technical Specification Group Radio Access Network; Evolved Universal Terrestrial Radio Access (E-UTRA); Requirements for support of radio resource management (Release 16), 3GPP, September 2020

Non-Patent Literature 2 3GPP TS38.331 V 16.2.0 3rd Generation Partnership Project; Technical Specification Group Radio Access Network; NR; Radio Resource Control (RRC); Protocol specification (Release 16), 3GPP, September 2020

### SUMMARY OF INVENTION

Against this background, the inventors, after careful consideration, found it necessary to consider Direct SCell Activation when defining the delay time required for PUCCH SCell activation in NR.

Therefore, the following disclosure has been made in view of this situation, and the purpose is to provide a terminal that can appropriately activate a secondary cell configured with a physical uplink control channel.

The summary of the disclosure is a terminal comprising: a reception unit that receives a first message requesting a configuration of a specific secondary cell configured with a physical uplink control channel; and a control unit that configures the specific secondary cell in response to the reception of the first message; wherein the control unit performs an activation of the specific secondary cell so as not to exceed a first request delay time in a first procedure for performing the activation of the specific secondary cell in response to receiving a second message requesting the activation of the specific secondary cell, and performs the activation of the specific secondary cell so as not to exceed a second request delay time in a second procedure for performing the activation of the specific secondary cell without depending on the second message.

### BRIEF DESCRIPTION OF DRAWINGS

FIG. 1 is an overall schematic configuration diagram of radio communication system 10.

FIG. 2 shows the frequency range used in radio communication system 10.

FIG. 3 shows an example configuration of the radio frame, subframe and slot used in radio communication system 10.

FIG. 4 shows a functional block configuration of the UE 200.

FIG. 5 shows an example of operation.

FIG. 6 shows an example of operation.

FIG. 7 shows an example of the hardware configuration of the UE 200.

### MODES FOR CARRYING OUT THE INVENTION

Exemplary embodiments of the present invention are explained below with reference to the accompanying drawings. Note that, the same or similar reference numerals have been attached to the same functions and configurations, and the description thereof is appropriately omitted.

### Embodiment

(1) Overall Schematic Configuration of the Radio Communication System

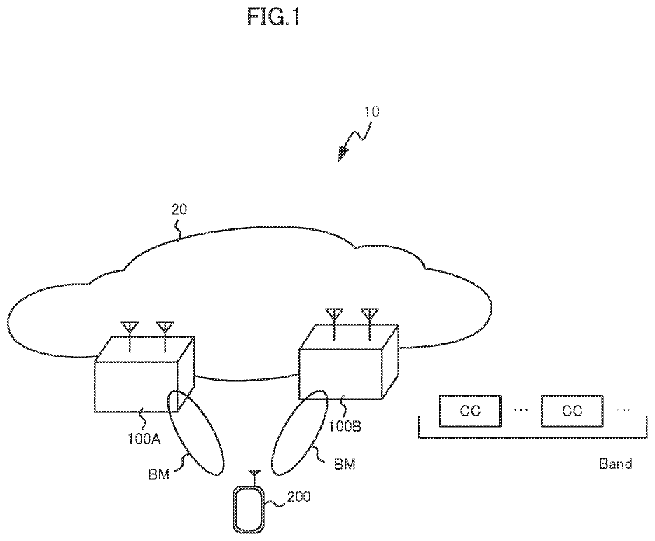

FIG. 1 is the overall schematic configuration of a radio communication system 10 according to the embodiment. The radio communication system 10 is a radio communication system according to 5G New Radio (NR) and includes a Next Generation-Radio Access Network 20 (herein below referred to as NG-RAN 20) and a terminal 200 (herein below referred to as UE 200).

The radio communication system 10 may be a radio communication system according to a scheme called Beyond 5G, 5G Evolution or 6 G.

The NG-RAN 20 includes a radio base station 100A (herein below referred to as gNB 100A) and a radio base station 100B (herein below referred to as gNB 100B). The specific configuration of radio communication system 10 including the number of gNBs and UEs is not limited to the example shown in FIG. 1.

The NG-RAN 20 actually contains multiple NG-RAN nodes, specifically gNBs (or ng-eNBs), and is connected to a core network (5GC, not shown) according to 5G. Note that the NG-RAN 20 and 5GCs may simply be described as a network.

The gNB 100A and gNB 100B are radio base stations in accordance with 5G and perform radio communication in accordance with the UE 200 and 5G. The gNB 100A, gNB 100B and UE 200 are capable of supporting Massive MIMO (Multiple-Input Multiple-Output) which generates a more directional beam BM by controlling radio signals transmitted from multiple antenna elements, carrier aggregation (CA) which uses multiple component carriers (CCs) bundled together, and dual connectivity (DC) which simultaneously communicates between the UE and each of the two NG-RAN nodes. The DC may include MR-DC (Multi-RAT Dual Connectivity) using MCG (Master Cell Group) and SCG (Secondary Cell Group). Cells belonging to MCG may be referred to as PCell (Primary Cell) and cells belonging to SCG (Secondary Cell Group) may be referred to as SCell (Secondary Cell). Examples of MR-DC include EN-DC (E-UTRA-NR Dual Connectivity), NE-DC (NR-EUTRA Dual Connectivity) and NR-DC (NR-NR Dual Connectivity). Here, CC (cell) used in CA may be considered to constitute the same cell group. The MCG and SCG may be considered to constitute the same cell group.

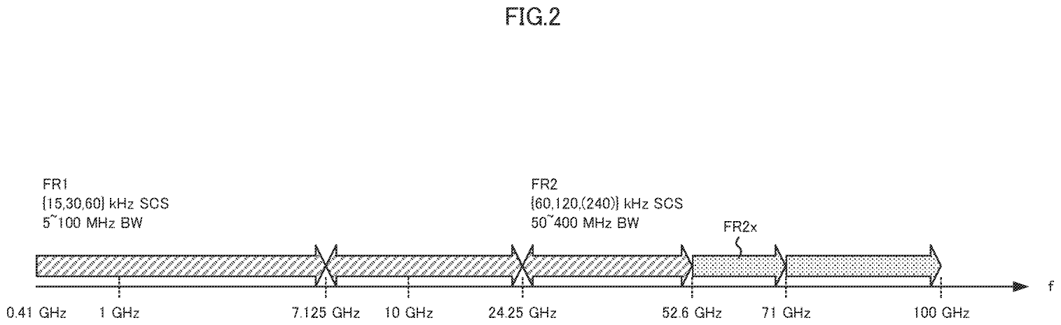

In addition, radio communication system 10 supports multiple frequency ranges (FRs). FIG. 2 shows the frequency ranges used in radio communication system 10.

As shown in FIG. 2, radio communication system 10 corresponds to FR1 and FR2. The frequency bands of each FR are as follows:
FR 1: 410 MHz to 7.125 GHz
FR 2: 24.25 GHz to 52.6 GHz

FR1 may use sub-carrier spacing (SCS) of 15, 30 or 60 kHz and a bandwidth (BW) of 5˜100 MHz. FR2 is a higher frequency than FR1, an SCS of 60 or 120 kHz (240 kHz may be included) may be used and a bandwidth (BW) of 50˜400 MHz may be used.

SCS may be interpreted as numerology. Numerology is defined in 3GPP TS38.300 and corresponds to one subcarrier interval in the frequency domain.

In addition, the radio communication system 10 corresponds to a higher frequency band than that of FR 2. Specifically, radio communication system 10 corresponds to a frequency band above 52.6 GHz and up to 114.25 GHz. Such a high frequency band may be referred to as “FR 2 x” for convenience.

To solve such problems, Cyclic Prefix-Orthologous Frequency Division Multiplexing (CP-OFDM)/Discrete Fourier Transform-Spread (DFT-S-OFDM) with larger Sub-Carrier Spacing (SCS) may be applied when using bands above 52.6 GHz.

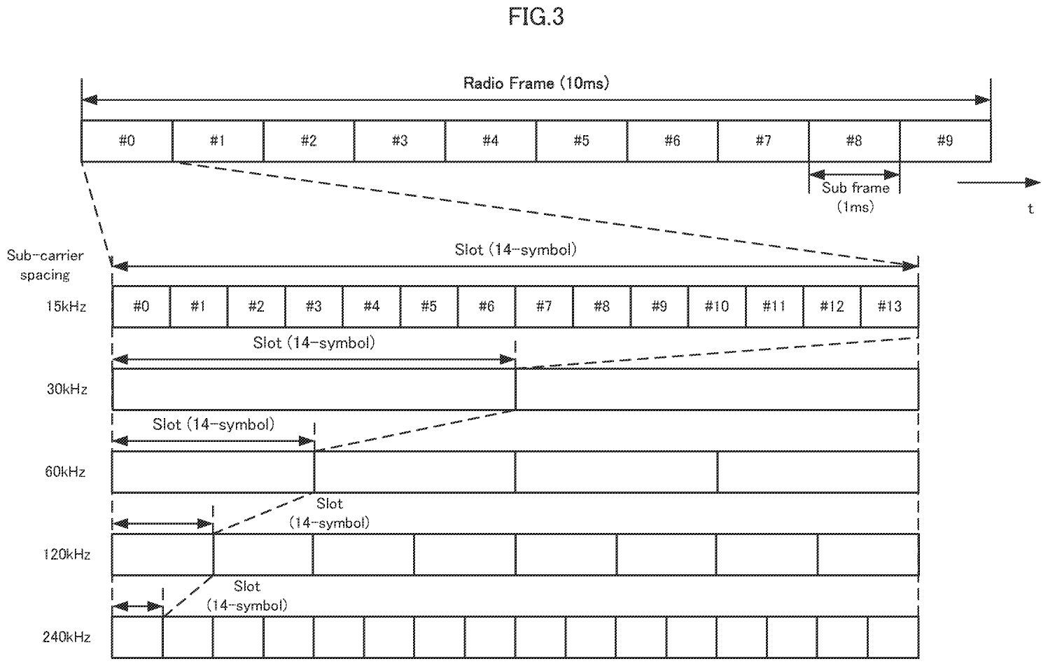

FIG. 3 shows an example configuration of the radio frame, subframe and slot used in radio communication system 10.

As shown in FIG. 3, one slot consists of 14 symbols, and the larger (wider) the SCS, the shorter the symbol period (and slot period). The SCS is not limited to the interval (frequency) shown in FIG. 3. For example, 480 kHz, 960 kHz, etc. may be used.

In addition, the number of symbols constituting 1 slot need not necessarily be 14 symbols (For example, 28, 56 symbols). Furthermore, the number of slots per subframe may vary depending on the SCS.

Note that the time direction (t) shown in FIG. 3 may be referred to as a time domain, symbol period or symbol time. The frequency direction may also be referred to as a frequency domain, resource block, subcarrier or BWP (Bandwidth Part).

(2) Function Block Configuration of Radio Communication System

Next, the functional block configuration of radio communication system 10 will be described. Specifically, the functional block configuration of the UE 200 will be described.

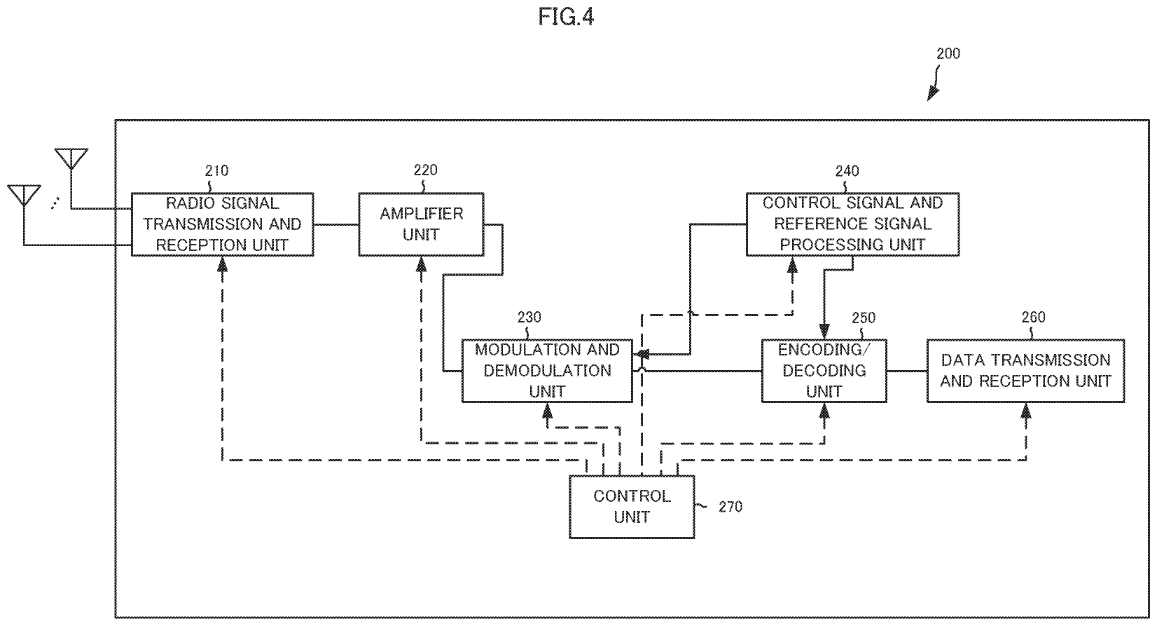

FIG. 4 is a functional block configuration diagram of the UE 200. As shown in FIG. 4, the UE 200 comprises a radio signal transmission and reception unit 210, an amplifier unit 220, a modulation and demodulation unit 230, a control signal and reference signal processing unit 240, an encoding/decoding unit 250, a data transmission and reception unit 260 and a control unit 270.

The radio signal transmission and reception unit 210 transmits and receives radio signals in accordance with NR. The radio signal transmission and reception unit 210 supports Massive MIMO, CA for bundling multiple CCs, and DC for simultaneously communicating between UE and each of the 2 NG-RAN nodes.

The amplifier unit 220 is composed of PA (Power Amplifier)/LNA (Low Noise Amplifier), etc. The amplifier unit 220 amplifies the signal output from the modulation and demodulation unit 230 to a prescribed power level. The amplifier unit 220 amplifies the RF signal output from radio signal transmission and reception unit 210.

The modulation and demodulation unit 230 performs data modulation/demodulation, transmission power setting and resource block allocation for each predetermined communication destination (gNB 100 or other gNB). On the modulation and demodulation unit 230, Cyclic Prefix-Orthogonal-Frequency Division Multiplexing (CP-OFDM)/Discrete Fourier Transform-Spread (DFT-S-OFDM) may be applied. DFT-S-OFDM may also be used for downlink (DL) as well as uplink (UL).

The control signal and reference signal processing unit 240 performs processing for various control signals transmitted and received by the UE 200 and processing for various reference signals transmitted and received by the UE 200.

Specifically, the control signal and reference signal processing unit 240 receives various control signals transmitted from the gNB 100 via a predetermined control channel, such as control signals of a radio resource control layer (RRC). The control signal and reference signal processing unit 240 also transmits various control signals toward the gNB 100 via a predetermined control channel.

The control signal and reference signal processing unit 240 performs processing using a reference signal (RS) such as a Demodulation Reference Signal (DMRS) and a Phase Tracking Reference Signal (PTRS).

DMRS is a known reference signal (pilot signal) between individual base stations and terminals for estimating a fading channel used for data demodulation. PTRS is a terminal-specific reference signal for the purpose of estimating phase noise, which is a problem in high frequency bands.

In addition to DMRS and PTRS, the reference signal may include a Channel State Information-Reference Signal (CSI-RS), a Sounding Reference Signal (SRS), and a Positioning Reference Signal (PRS) for location information.

The channel also includes a control channel and a data channel. The control channels include PDCCH (Physical Downlink Control Channel), PUCCH (Physical Uplink Control Channel), RACH (Random Access Channel), Downlink Control Information (DCI) including Random Access Radio Network Temporary Identifier (RA-RNTI), and Physical Broadcast Channel (PBCH).

The data channels include PDSCH (Physical Downlink Shared Channel) and PUSCH (Physical Uplink Shared Channel). Data means data transmitted through a data channel. A data channel may be read as a shared channel.

In an embodiment, the control signal and reference signal processing unit 240 constitutes a reception unit that receives a first message requesting the configuration of a specific secondary cell (hereinafter PUCCH SCell) configured with a physical uplink control channel (PUCCH). The first message may be an RRC message. The RRC message may be an RRC Reconfiguration message. The RRC message may contain information elements that direct the addition or modification of PUCCH SCell configuration. The RRC message may contain information elements (For example, sCellState) that direct the activation of PUCCH SCell without depending on the second message described below. The sCellState may be included in the information elements (3GPP TS38.331 V 16.2.0 section 6.3.2 “Radio resource control information elements”) for configuring the MCG or SCG. control signal and reference signal processing unit 240 may receive a second message requesting activation of the PUCCH SCell. The second message may be a MAC CE message. The MAC CE message may be received via PDCCH. The information element that requires activation of PUCCH SCell may be referred to as SCell activation.

The encoding/decoding unit 250 performs data segmentation/concatenation and channel coding/decoding for each predetermined communication destination (gNB 100 or other gNB).

Specifically, the encoding/decoding unit 250 divides the data output from the data transmission and reception unit 260 into predetermined sizes and performs channel coding on the segmented data. The encoding/decoding unit 250 also decodes the data output from modulation and demodulation unit 230 and concatenates the decoded data.

The data transmission and reception unit 260 transmits and receives protocol data units (PDU) and service data units (SDU). Specifically, the data transmission and reception unit 260 performs assembly/disassembly of PDUs/SDUs in multiple layers (Media access control layer (MAC), radio link control layer (RLC), and packet data convergence protocol layer (PDCP), etc.). data transmission and reception unit 260 also performs error correction and retransmission control of data based on a hybrid automatic repeat request (ARQ).

The control unit 270 controls each functional block that makes up the UE 200. In particular, in an embodiment, the control unit 270 constitutes a control unit that configures the PUCCH SCell in response to receiving the first message (RRC message below).

The control unit 270 performs the first procedure (Below: Normal SCell activation) of activating the PUCCH SCell in response to receiving the second message (MAC CE messages below) requesting the activation of the PUCCH SCell. For example, the control unit 270 may perform Normal SCell activation if the RRC message does not contain sCellState. The control unit 270 may configure PUCCH SCell in the inactive state if the RRC message does not contain sCellState. control unit 270 performs activation of PUCCH SCell so as not to exceed the first request delay time in Normal SCell activation. For example, when receiving a control unit CE message, the control unit 270 enters a state in which it can transmit a valid CSI report so as not to be later than the slot defined by the first request delay time, and also performs operations related to activation of PUCCH SCell.

If it is synchronized with the activating PUCCH SCell, the first request delay time need not include the delay time for the procedure (TA (Timing Advance) alignment) to synchronize with the activating PUCCH SCell. If it is not synchronized with the activating PUCCH SCell, the first request delay time need not include the delay time for the TA alignment. The delay time for the TA alignment may be referred to as T₁, T₂, T₃, etc.

The control unit 270 performs the second procedure (Below, Direct SCell activation) of activating PUCCH SCell without a MAC CE message requesting PUCCH SCell activation. For example, the control unit 270 may perform Direct SCell activation if the RRC message contains sCellState. The control unit 270 may configure PUCCH SCell in the active state if the RRC message contains sCellState. In Direct SCell activation, the control unit 270 performs activation of PUCCH SCell so as not to exceed the second request delay time. For example, when the control unit 270 receives an RRC message, it is in a state to be able to send a valid CSI report so as not to be later than the slot defined by the second request delay time, and it also performs operations related to activation of PUCCH SCell.

If it is synchronized with the activating PUCCH SCell, the second request delay time may not include the delay time for the procedure (TA alignment) to synchronize with the activating PUCCH SCell. If it is not synchronized with the activating PUCCH SCell, the second request delay time may include the delay time for the TA alignment. The delay time for the TA alignment may be referred to as T₁, T₂, T₃, etc.

Under these assumptions, the second request delay time used for Direct SCell activation may be defined separately from the first request delay time used for Normal SCell activation. The second request delay time used for Direct SCell activation may be shorter than the first request delay time used for Normal SCell activation. Furthermore, at least one of the first and second request delay times may be defined according to the SCS of the PUCCH SCell being activated. At least one of the first and second request delay times may be defined according to the SCS of the PUCCH SCell being activated when the SCS is different between the CCs.

(3) Example of Operation

An example of operation of the embodiment will be described below. The activation of PUCCH SCell will be described below.

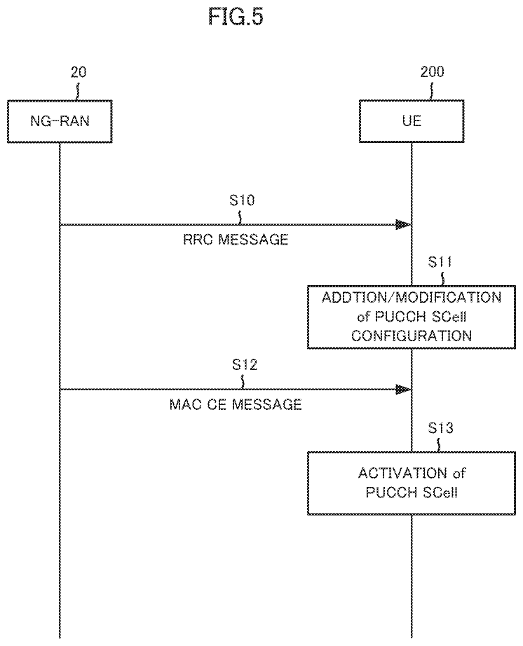

First, the first procedure (Normal SCell activation) will be described with reference to FIG. 5.

As shown in FIG. 5, in step S10, the UE 200 receives an RRC message requesting the configuration of PUCCH SCell. The RRC message may include information elements instructing the addition or modification of PUCCH SCell configuration. For example, in Normal SCell activation, the sCellState described above is not included in the RRC message.

In step S11, the UE 200 performs the addition or modification of the PUCCH SCell configuration in response to the RRC message. The UE 200 configures the PUCCH SCell in the inactive state.

In step S12, the UE 200 receives a MAC CE message. For example, the MAC CE message includes an information element (SCell activation) that requests activation of PUCCH SCell.

In step S13, the UE 200 performs activation of PUCCH SCell in response to the MAC CE message. Here, the UE 200 performs activation of PUCCH SCell so as not to exceed the first request delay time.

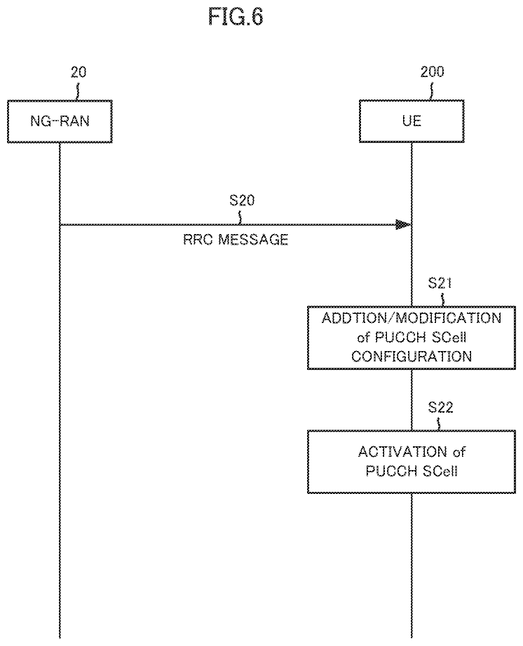

Second, the second procedure (Direct SCell activation) will be described with reference to FIG. 6.

As shown in FIG. 6, in step S20, the UE 200 receives an RRC message requesting the configuration of PUCCH SCell. The RRC message may include an information element instructing the addition or modification of the PUCCH SCell configuration. For example, in Direct SCell activation, the sCellState described above is included in the RRC message.

In step S21, the UE 200 performs the addition or modification of the PUCCH SCell configuration in response to the RRC message.

In step S22, the UE 200 configures the PUCCH SCell in the active state in response to the RRC message. That is, the UE 200 performs the activation of the PUCCH SCell without depending on the MAC CE message. Here, the UE 200 performs the activation of the PUCCH SCell so as not to exceed the second request delay time.

(4) Operational Effects

In the embodiment, the UE 200 performs activation of PUCCH SCell so as not to exceed the first request delay time in the first procedure (Normal SCell activation) and PUCCH SCell so as not to exceed the second request delay time in the second procedure (Direct SCell activation). With such a configuration, PUCCH SCell can be activated appropriately because Direct SCell Activation is considered in defining the delay time required for PUCCH SCell activation in NR.

### Modification Example 1

Modification Example 1 of the embodiment will be described below. Differences from the embodiment will be described below.

Modification Example 1 describes the second procedure (Below, Direct SCell activation at Handover) in handover to a specific secondary cell (PUCCH SCell).

The second request delay time used in Direct SCell activation at Handover is defined without considering the delay time for the procedure (TA Alignment) to synchronize with PUCCH SCell. In other words, in Direct SCell activation at Handover, PUCCH SCell activation is performed on the assumption that it is synchronized with the target cell (PUCCH SCell), so the second request delay time does not include the delay time for TA Alignment.

The second request delay time used in Direct SCell activation at Handover may be the same as the second request delay time used in Direct SCell activation that is synchronized with the activating PUCCH SCell.

### Other Embodiments

Although the contents of the present invention have been described above in accordance with the embodiment, the present invention is not limited to these descriptions, and it is obvious to those skilled in the art that various modifications and improvements are possible.

In the above disclosure, the SCell in which PUCCH is configured (PUCCH SCell) is mainly described. However, the above disclosure is not limited to this. For example, SCell activation may include activation of SCells for which PUCCH is not configured (Normal SCell). As the delay time for Normal SCell, the delay time already specified in 3GPP may be used (3GPP TS38.133, section 8.3, “SCell Activation and Deactivation Delay,” section 8.4, “Direct SCell Activation at SCell addition” section 8.5, “Direct SCell Activation at Handover”).

Although not specifically mentioned in the above disclosure, the delay time for PUCCH SCell in LTE may be used as the first request delay time used in NR's Normal SCell activation (TS36.133 V 16.7.0, section 7.7.6 “SCell Activation Delay Requirement for Deactivated PUCCH SCell,” section 7.7.7 “SCell Activation Delay Requirement for Deactivated PUCCH SCell with Multiple SCells”).

Even in the above case, it should be noted that the second request delay time used in the Direct SCell activation for PUCCH SCell needs to be newly introduced.

The block diagram (FIG. 4) used in the description of the above embodiment shows a block of functional units. Those functional blocks (structural components) can be realized by a desired combination of at least one of hardware and software. Means for realizing each functional block is not particularly limited. That is, each functional block may be realized using one device that is physically or logically coupled, or two or more devices that are physically or logically separated may be directly or indirectly connected (For example, using wired, wireless, etc.) and realized using these multiple devices. The functional block may be realized by combining the software with the one device or the multiple devices.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, the functional block (component) that makes transmission work is called a transmission unit (transmitting unit) or transmitter. In either case, as described above, the implementation method is not particularly limited.

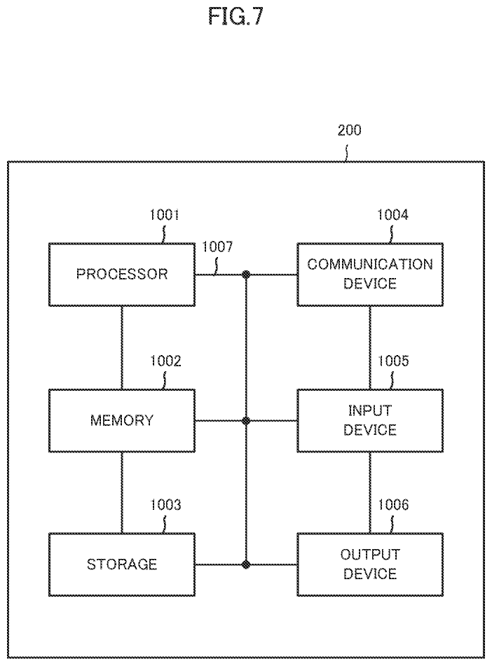

Furthermore, the UE 200 (the device) described above may function as a computer that performs processing of the radio communication method of this disclosure. FIG. 7 shows an example of the hardware configuration of the device. As shown in FIG. 7, the device may be configured as a computer device including a processor 1001, a memory 1002, a storage 1003, an communication device 1004, an input device 1005, an output device 1006, a bus 1007, etc.

Furthermore, in the following explanation, the term “device” can be replaced with a circuit, device, unit, and the like. The hardware configuration of the device may be configured to include one or more of each device shown in the figure, or it may be configured without some of the devices.

Each functional block of the device (see FIG. 4) is realized by any hardware element of the computer device, or a combination of the hardware elements.

Moreover, the processor 1001 performs computing by loading a predetermined software (computer program) on hardware such as the processor 1001 and the memory 1002, and realizes various functions of the reference device by controlling communication via the communication device 1004, and controlling reading and/or writing of data on the memory 1002 and the storage 1003.

The processor 1001 controls the entire computer by, for example, operating the operating system. The processor 1001 may consist of a central processing unit (CPU) including interfaces with peripheral devices, controllers, arithmetic units, registers, etc.

Moreover, the processor 1001 reads a computer program (program code), a software module, data, and the like from the storage 1003 and/or the communication device 1004 into the memory 1002, and performs various processes according to the data. As the computer program, a computer program that is capable of executing on the computer at least a part of the operation explained in the above embodiments is used. Furthermore, the various processes described above may be executed by one processor 1001 or simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. The memory 1002 may be referred to as a register, a cache, a main memory (main memory), etc. The memory 1002 may store a program (program code), a software module, etc., capable of executing a method according to one embodiment of this disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

Each device such as a processor 1001 and a memory 1002 is connected by a bus 1007 for communicating information. The bus 1007 may be configured using a single bus or different buses for each device.

Furthermore, the device may be configured including hardware such as a microprocessor, a digital signal processor (DSP), an application specific integrated circuit (ASIC), a programmable logic device (PLD), a field programmable gate array (FPGA), etc., with which some or all of the functional blocks may be implemented. For example, the processor 1001 may be implemented by using at least one of these hardware.

Also, the notification of information is not limited to the mode/embodiment described in this disclosure and may be made using other methods. For example, notification of information may be implemented by physical layer signaling (e.g., Downlink Control Information (DCI), Uplink Control Information (UCI), higher layer signaling (e.g., RRC signaling, Medium Access Control (MAC) signaling, notification information (Master Information Block (MIB), System Information Block (SIB)), other signals or a combination thereof. The RRC signaling may also be referred to as an RRC message, e.g., an RRC Connection Setup message, an RRC Connection Reconfiguration message, etc.

Each of the above aspects/embodiments can be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G).

The processing procedures, sequences, flowcharts, etc., of each mode/embodiment described in this disclosure may be reordered as long as there is no conflict. For example, the method described in this disclosure uses an illustrative order to present elements of various steps and is not limited to the specific order presented.

The specific operation that is performed by the base station in the present disclosure may be performed by its upper node in some cases. In a network consisting of one or more network nodes with base stations, it is clear that various operations performed for communication with terminals can be performed by the base station and at least one of the other network nodes (For example, but not limited to MME or S-GW) other than the base station. In the above, an example in which there is one network node other than the base station is explained; however, a combination of a plurality of other network nodes (for example, MME and S-GW) may be used.

Information, signals (information, etc.) can be output from an upper layer (or lower layer) to a lower layer (or upper layer). It may be input and output via a plurality of network nodes.

The input/output information can be stored in a specific location (for example, a memory) or can be managed in a management table. Information that is input or output can be overwritten, updated, or appended. The information can be deleted after outputting. The inputted information can be transmitted to another device.

The determination may be made by a value represented by a single bit (0 or 1), by a truth value (Boolean: true or false), or by comparing numbers (For example, a comparison with a given value).

Each aspect/embodiment described in this disclosure may be used alone, in combination, or switched as execution proceeds. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, if the software is transmitted from a website, server, or other remote source using at least one of wired technology (Coaxial cable, fiber optic cable, twisted pair, Digital subscriber Line (DSL), etc.) and wireless technology (Infrared, microwave, etc.), at least one of these wired and wireless technologies is included within the definition of a transmission medium.

Information, signals, or the like mentioned above may be represented by using any of a variety of different technologies. For example, data, instructions, commands, information, signals, bits, symbols, chips, etc. that may be referred to throughout the above description may be represented by voltage, current, electromagnetic wave, magnetic field or magnetic particle, light field or photon, or any combination thereof.

It should be noted that the terms described in this disclosure and those terms necessary for the understanding of this disclosure may be replaced with terms having the same or similar meanings. For example, at least one of the channels and symbols may be a signal (signaling). Also, the signal may be a message. Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS),” “radio base station,” “fixed station,” “NodeB,” “eNodeB (eNB),” “gNodeB (gNB),” “access point,” “transmission point,” “reception point,” “transmission/reception point,” “cell,” “sector,” “cell group,” “carrier,” “component carrier,” and the like can be used interchangeably. The base station may also be referred to with the terms such as a macro cell, a small cell, a femtocell, or a pico cell.

A base station can house one or more (For example, three) cells, also called sectors. In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a base station performing communication services in this coverage and to part or all of the coverage area of at least one of the base station subsystems.

In the present disclosure, the terms “mobile station (Mobile Station: MS),” “user terminal,” “user equipment (User Equipment: UE),” “terminal” and the like can be used interchangeably.

A mobile station may be referred to by those skilled in the art as a subscriber station, mobile unit, subscriber unit, wireless unit, remote unit, mobile device, radio communication device, remote device, mobile subscriber station, access terminal, mobile terminal, wireless terminal, remote terminal, handset, user agent, mobile client, client, or some other appropriate term.

At least one of a base station and a mobile station may be called a transmitting device, a receiving device, a communication device, or the like. Note that, at least one of a base station and a mobile station may be a device mounted on a moving body, a moving body itself, or the like. The mobile may be a vehicle (For example, cars, airplanes, etc.), an unattended mobile (For example, drones, self-driving cars, etc.), or a robot (manned or unmanned). At least one of a base station and a mobile station can be a device that does not necessarily move during the communication operation. For example, at least one of a base station and a mobile station may be an Internet of Things (IoT) device such as a sensor.

The base station in this disclosure may also be read as a mobile station (user terminal, hereinafter the same). For example, each mode/embodiment of this disclosure may be applied to a configuration in which communication between a base station and a mobile station is replaced with communication between multiple mobile stations (For example, it may be called Device-to-Device (D2D), Vehicle-to-Everything (V2X), etc.). In this case, the mobile station may have the function of the base station. In addition, words such as “up” and “down” may be replaced with words corresponding to communication between terminals (For example, “side”). For example, terms an uplink channel, a downlink channel, or the like may be read as a side channel.

Similarly, mobile stations in this disclosure may be replaced with base stations. In this case, the base station may have the function of the mobile station.

A radio frame may consist of one or more frames in the time domain. Each one or more frames in the time domain may be referred to as a subframe.

A subframe may further consist of one or more slots in the time domain. A subframe may have a fixed length of time (For example, 1 ms) independent of numerology.

Numerology may be a communication parameter applied to at least one of the transmission and reception of a signal or channel. The numerology can include one among, for example, subcarrier spacing (SubCarrier Spacing: SCS), bandwidth, symbol length, cyclic prefix length, transmission time interval (Transmission Time Interval: TTI), number of symbols per TTI, radio frame configuration, a specific filtering process performed by a transceiver in the frequency domain, a specific windowing process performed by a transceiver in the time domain, and the like.

Slots may consist of one or more symbols (Orthologous Frequency Division Multiplexing (OFDM)) symbols, Single Carrier Frequency Division Multiple Access (SC-FDMA) symbols, etc., in the time domain. A slot may be a unit of time based on the numerology.

A slot may include a plurality of minislots. Each minislot may consist of one or more symbols in the time domain. A minislot may also be called a subslot. A minislot may be composed of fewer symbols than slots. A PDSCH (or PUSCH) transmitted in units of time larger than the minislot may be referred to as a PDSCH (or PUSCH) mapping type A. A PDSCH (or PUSCH) transmitted using a minislot may be referred to as a PDSCH (or PUSCH) mapping type B.

Each of the radio frame, subframe, slot, minislot, and symbol represents a time unit for transmitting a signal. Different names may be used for the radio frame, subframe, slot, minislot, and symbol.

For example, one subframe may be referred to as a transmission time interval (TTI), multiple consecutive subframes may be referred to as TTI, or one slot or one minislot may be referred to as TTI. That is, at least one of the subframes and TTI may be a subframe (1 ms) in existing LTE, a period shorter than 1 ms (For example, 1-13 symbols), or a period longer than 1 ms. Note that, a unit representing TTI may be called a slot, a minislot, or the like instead of a subframe.

Here, TTI refers to the minimum time unit of scheduling in radio communication, for example. Here, TTI refers to the minimum time unit of scheduling in radio communication, for example. For example, in the LTE system, the base station performs scheduling for allocating radio resources (frequency bandwidth, transmission power, etc. that can be used in each user terminal) to each user terminal in units of TTI. The definition of TTI is not limited to this.

The TTI may be a transmission time unit such as a channel-encoded data packet (transport block), a code block, or a code word, or may be a processing unit such as scheduling or link adaptation. When TTI is given, a time interval (for example, the number of symbols) in which a transport block, a code block, a code word, etc. are actually mapped may be shorter than TTI.

If one slot or one minislot is called a TTI, one or more TTIs (That is, one or more slots or one or more minislots) may be the minimum unit of time for scheduling. In addition, the number of slots (number of minislots) constituting the minimum unit of time for scheduling may be controlled.

TTI having a time length of 1 ms may be referred to as an ordinary TTI (TTI in LTE Rel. 8-12), a normal TTI, a long TTI, a normal subframe, a normal subframe, a long subframe, a slot, and the like. TTI, which is usually shorter than TTI, may be called shortened TTI, short TTI, partial or fractional TTI, shortened subframe, short subframe, minislot, subslot, slot, etc.

In addition, a long TTI (for example, ordinary TTI, subframe, etc.) may be read as TTI having a time length exceeding 1 ms, and a short TTI (for example, shortened TTI) may be read as TTI having TTI length of less than the TTI length of the long TTI but TTI length of 1 ms or more.

A resource block (RB) is a unit of resource allocation in the time and frequency domains and may include one or more consecutive subcarriers in the frequency domain. The number of subcarriers included in RB may be, for example, twelve, and the same regardless of the topology. The number of subcarriers included in the RB may be determined based on the neurology.

The time domain of the RB may also include one or more symbols and may be one slot, one minislot, one subframe, or one TTI long. One TTI, one subframe, and the like may each consist of one or more resource blocks.

One or more RBs may be referred to as Physical RB (PRB), Sub-Carrier Group (SCG), Resource Element Group (REG), PRB pair, RB pair, etc.

A resource block may also be composed of one or more Resource Elements (RE). For example, one RE may be a radio resource area of one subcarrier and one symbol.

A bandwidth part (BWP) (which may be called a partial bandwidth, etc.) may represent a subset of contiguous common resource blocks (RBs) for a certain neurology in a certain carrier. Here, the common RB may be identified by an index of RBs with respect to the common reference point of the carrier. PRB may be defined in BWP and numbered within that BWP.

BWP may include UL BWP (UL BWP) and DL BWP (DL BWP). For a UE, one or more BWPs may be set within a carrier.

At least one of the configured BWPs may be active, and the UE may not expect to send and receive certain signals/channels outside the active BWP. Note that “cell,” “carrier,” and the like in this disclosure may be read as “BWP.”

The above-described structures such as a radio frame, subframe, slot, minislot, and symbol are merely examples. For example, configurations such as the number of subframes included in a radio frame, the number of subframes or slots per radio frame, the number of minislots included in a slot, the number of symbols and RBs included in a slot or minislot, the number of subcarriers included in an RB, and the number of symbols, symbol length, and Cyclic Prefix (CP) length in a TTI may be varied variably.

The terms “connected,” “coupled” or any variation thereof mean any connection or combination, directly or indirectly, between two or more elements and may include the presence of one or more intermediate elements between two elements that are “connected” or “coupled” to each other. The connection or connection between elements may be physical, logical, or a combination of these. For example, “connection” may be read as “access.” As used in this disclosure, the two elements may be considered to be “connected” or “coupled” to each other using at least one of one or more wire, cable, and printed electrical connections and, as a few non-limiting and non-comprehensive examples, electromagnetic energy with wavelengths in the radio frequency domain, the microwave domain, and the optical (both visible and invisible) domain.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on.”

The “means” in the configuration of each apparatus may be replaced with “unit,” “circuit,” “device,” and the like.

Any reference to elements using designations such as “first” or “second” as used in this disclosure does not generally limit the amount or order of those elements. Such designations can be used in the present disclosure as a convenient way to distinguish between two or more elements. Thus, references to the first and second elements do not imply that only two elements can be adopted there or that the first element must in some way precede the second element.

In the present disclosure, the used terms “include,” “including,” and variants thereof are intended to be inclusive in a manner similar to the term “comprising.” Furthermore, the term “or (or)” as used in this disclosure is not intended to be an exclusive OR.

Throughout this disclosure, for example, during translation, if articles such as a, an, and the in English are added, in this disclosure, these articles shall include plurality of nouns following these articles.

As used in this disclosure, the terms “determining,” “judging” and “deciding” may encompass a wide variety of actions. “Judgment” and “decision” includes judging or deciding by, for example, judging, calculating, computing, processing, deriving, investigating, looking up, search, inquiry (e.g., searching in a table, database, or other data structure), ascertaining, and the like. In addition, “judgment” and “decision” can include judging or deciding by receiving (for example, receiving information), transmitting (for example, transmitting information), input (input), output (output), and access (accessing) (e.g., accessing data in a memory). In addition, “judgement” and “decision” can include judging or deciding by resolving, selecting, choosing, establishing, and comparing. That is, “judgment” and “determination” may include regarding some action as “judgment” and “determination.” Moreover, “judgment (decision)” may be read as “assuming,” “expecting,” “considering,” and the like.

In the present disclosure, the term “A and B are different” may mean “A and B are different from each other.” It should be noted that the term may mean “A and B are each different from C.” Terms such as “leave,” “coupled,” or the like may also be interpreted in the same manner as “different.”

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### EXPLANATION OF REFERENCE NUMERALS

10 radio communication system

20 NG-RAN

100 gNB

200 UE

210 radio signal transmission and reception unit

220 amplifier unit

230 modulation and demodulation unit

240 control signal and reference signal processing unit

250 encoding/decoding unit

260 data transmission and reception unit

270 control unit

1001 processor

1002 memory

1003 storage

1004 communication device

1005 input device

1006 output device

1007 bus

1. A terminal comprising:
a reception unit that receives a first message requesting a configuration of a specific secondary cell configured with a physical uplink control channel; and
a control unit that configures the specific secondary cell in response to the reception of the first message; wherein
the control unit
performs an activation of the specific secondary cell so as not to exceed a first request delay time in a first procedure for performing the activation of the specific secondary cell in response to receiving a second message requesting the activation of the specific secondary cell, and
performs the activation of the specific secondary cell so as not to exceed a second request delay time in a second procedure for performing the activation of the specific secondary cell without depending on the second message.

2. The terminal of claim 1, wherein
the second request delay time is defined separately from the first request delay time.

3. The terminal according to claim 1, wherein
the second request delay time is shorter than the first request delay time.

4. The terminal according to claim 1, wherein
the second request delay time in the handover to the specific secondary cell is defined without considering a delay time regarding a procedure for synchronizing with the specific secondary cell.

5. The terminal according to claim 2, wherein
the second request delay time in the handover to the specific secondary cell is defined without considering a delay time regarding a procedure for synchronizing with the specific secondary cell.

6. The terminal according to claim 3, wherein
the second request delay time in the handover to the specific secondary cell is defined without considering a delay time regarding a procedure for synchronizing with the specific secondary cell.
